(19) United States
(12) Patent Application Publication
(10) Pub. No.: US 2012/0278642 A1
(43) Pub. Date: Nov. 1, 2012

(54) CENTRALIZED POWER AND HEAT MANAGEMENT FOR DATA DISK DRIVES OF A DATA STORAGE SYSTEM

(75) Inventor: Sourin Sarkar, Durgapur (IN)

(73) Assignee: LSI Corporation, Milpitas, CA (US)

(21) Appl. No.: 13/097,269

(22) Filed: Apr. 29, 2011

(51) Int. Cl. G06F 1/24

(52) U.S. Cl. 713/323

(57) ABSTRACT

A method of controlling spinning of data disk drives, a data storage system including multiple data disk drives and a power zone aware device are disclosed herein. In one embodiment, the power zone aware device includes: (1) a policy module configured to define at least one power zone in the data storage system and assign a power zone policy thereto and (2) a management module coupled configured to direct operation of data disk drives in the power zone based on the power zone policy.

### TECHNICAL FIELD

This application is directed, in general, to data centers, and, more specifically, to power and heat management in data centers.

### BACKGROUND

Data centers typically include computer systems and associated devices that are connected together to provide a data storage system. Large data centers may include multiple computer systems that are networked together to provide data storage that is secure, redundant and continually available. As such, data centers can consume a lot of electrical power for 24×7 operations. For example, massive amounts of electrical energy may be used in powering up and continuously spinning hard disk drives used in the data centers to store data. Data centers, for example, may have a topology that includes Serial Advanced Technology Attachment (SATA) disks or Serial Attached SCSI (SAS) disks.

To reduce electrical consumption, data centers can upgrade to storage devices that require less power, such as, low wattage hard disk drives. Data centers could also upgrade to other more power efficient storage enclosures. Either way, upgrading the data storing equipment can be expensive and require downtime. Accordingly, upgrading data storage equipment may not be practical for legacy data centers.

### SUMMARY

In one aspect, the disclosure provides a power zone aware device of a data storage system. In one embodiment, the device includes: (1) a policy module configured to define at least one power zone in the data storage system and assign a power zone policy thereto and (2) a management module coupled configured to direct operation of data disk drives in the power zone based on the power zone policy.

In another aspect, the disclosure provides a method of controlling spinning of data disk drives in a data storage system. In one embodiment, the method includes, comprising: (1) defining logical power zones within the data storage system, (2) assigning a power zone policy to each of the logical power zones; and (3) controlling spinning of data disk drives within each of the logical power zones based on the power zone policy assigned to the each of the logical power zones.

In yet another aspect, the disclosure provides a data storage system. In one embodiment, the data storage system includes: (1) multiple hard disk drives and (2) a power zone aware device coupled to the multiple hard disk drives, power zone aware device having (2A) a policy module configured to define at least one power zone for the multiple hard disk drives and assign a power zone policy thereto and (2B) a management module configured to direct operation of the multiple hard disk drives in the power zone based on the power zone policy.

### BRIEF DESCRIPTION

Reference is now made to the following descriptions taken in conjunction with the accompanying drawings, in which:

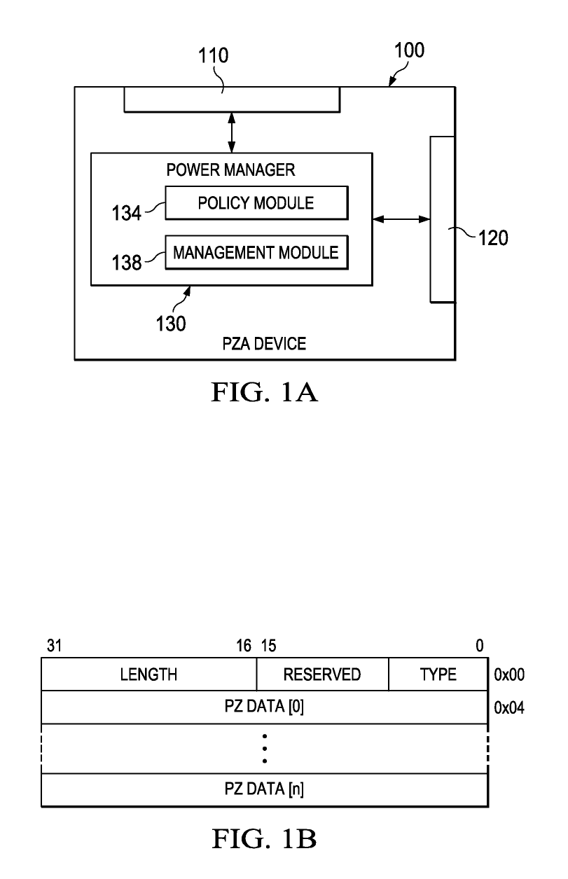

FIG. 1A illustrates a block diagram of one embodiment of a power zone aware (PZA) device constructed according to the principles of the disclosure;

FIG. 1B illustrates a data structure layout for an embodiment of a power zone administration table constructed according to the principles of the disclosure;

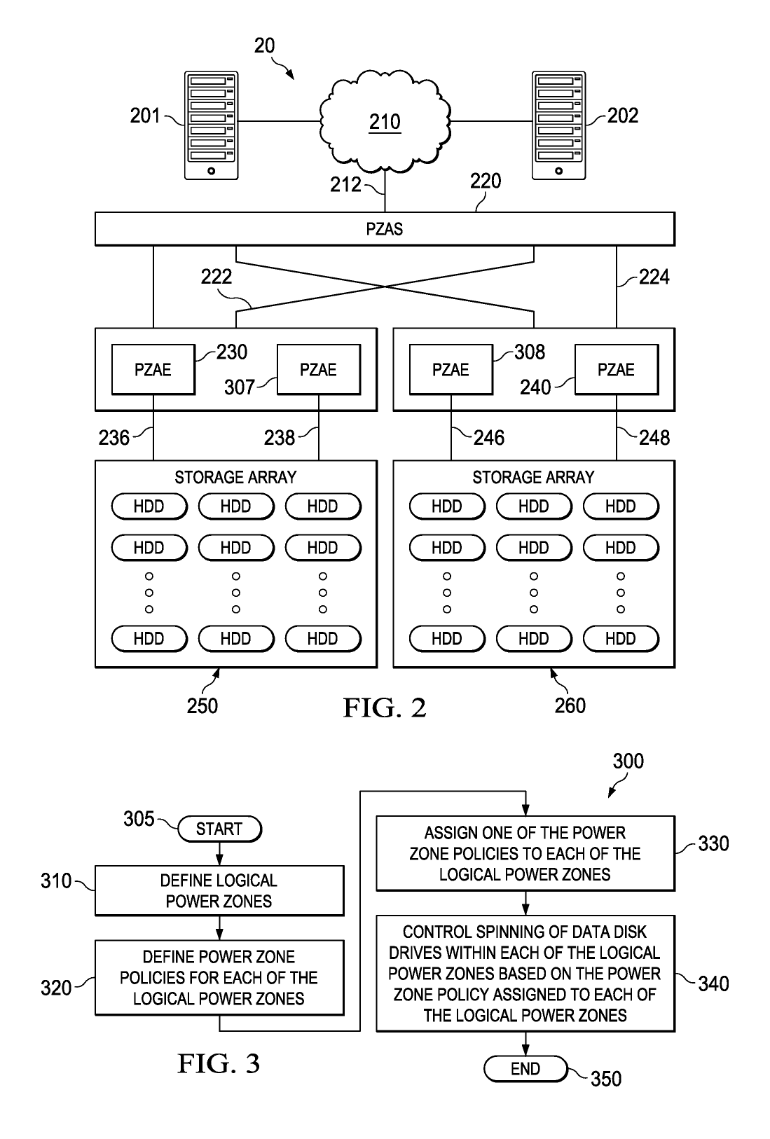

FIG. 2 illustrates a block diagram of one embodiment of a data storage system constructed according to the principles of the disclosure; and

FIG. 3 illustrates a flow diagram of one embodiment of a method of controlling spinning of data disk drives of a data storage system carried out according to the principles of the disclosure.

### DETAILED DESCRIPTION

This disclosure describes controlling the power consumption of storage topologies by employing power zones. The power zones can be employed to reduce power consumption of storage topologies by, for example, efficiently spinning down idle hard disk drives thereof. By spinning down disk drives, heat dissipation from spinning hard drives can also be effectively reduced. Accordingly, the power zones can be used to perform centralized, efficient and cost effective power and heat management for different storage topologies. In one embodiment, the storage topology may be a Storage Area Network (SAN).

In addition to being used with larger storage topologies, such as a SAN, the power zones disclosed herein may also be employed with other types of storage topologies. For example, the power zones may be used in tandem with SAS defined zones, such as SAS-2 defined zones. SAS-2 zoning concept has no feature/concept for power management or power policy deployment. However, SAS-2 defined ‘zones’ address access permission or visibility control for end-devices behind zoning expander devices. The disclosed power zones may be deployed in a manner so as to work in tandem with SAS-2 zone definitions. As such, the power zones employed for power and heat management can be tied to the zoning features of a SAS system through configuration options. In this case, the power zones may use the SAS zone definitions, such as SAS-2 zone definitions, for power and heat management. With SAS-2 zone definitions, various end devices coupled to expanders may be added to the different power zones. By being able to tie into existing defined zones, the disclosed power zone technique allows out of box self managed deployment for expander devices.

Coupling of the power zones with other storage topologies, such as, SAS-2 defined zones, may be based on a configurable parameter. An administrator may enable or disable the parameter to determine coupling. For example, in one embodiment, self managed deployment for expander devices may be implemented by: (1) Determining SAS-2 zone definitions by a zone administrator and (2) Coupling of the SAS-2 zoning definitions with a power zone policy.

The coupling parameter can be used to determine if a zoned portion of a storage topology also participates in a particular power zone policy. For example, a storage administrator may define a set of high performance hard disk drives to be in zone-60 and couples with a power zone policy having a power operating mode of a Hot Power Zone. This would reduce the hassle of redefining or recreating a list of hard disk drives or interfaces explicitly while creating the power zone policy for those same hard disk drives. Accordingly, the storage administrator can assign “SAS-2 Zone-60” (as defined by the storage administrator) also participates in “Power Zone Policy of Hot Power Zone.”

FIG. 1 illustrates a block diagram of one embodiment of a power zone aware (PZA) device 100 constructed according to the principles of the disclosure. The PZA device 100 may be employed in a data storage system. For example, the PZA device 100 may be a switch or an expander of a SAN. Thus, a PZA device may be a power zone aware switch (PZAS) or a power zone aware expander (PZAE). In some embodiments, the switch may be a SAS switch manufactured by LSI Corporation of Milpitas, Calif. Additionally, in some embodiments, the expander may be a SAS expander IC from LSI Corporation.

The PZA device 100 includes an upstream interface 110, a downstream interface 120 and a power manager 130. The upstream interface 110 and the downstream interface 120 may be conventional interfaces that are used to couple data storage equipment together for data communication. The interfaces 110, 120, provide a connection to upstream and downstream devices coupled to the PZA device 100. The upstream and downstream interfaces 110, 120, may also provide access for an administrator to communicate with the power manager 130.

The power manager 130 is configured to employ power zones to control spinning of data disk drives, e.g., hard disk drives, coupled to the PZA device 100 via the downstream interface 120. To perform the described functions, the power manager 130 may be embodied as a series of operating instruction stored on a non-transitory computer-readable medium that directs the operation of a processor when initiated thereby. Accordingly, the power manager 130 may include a processor and an associated memory. In one embodiment, the power manager 130 may be a dedicated computing device including the necessary circuitry (including a processor and memory) or software to perform the described functions. The power manager 130 may be a software/firmware module that is deployed or integrated within the PZA device 100. In some embodiments, the power manager 130 or at least a part thereof may be integrated within a processor of the PZA device 100. The power manager 130 includes a policy module 134 and a management module 138.

The policy module 134 includes zone policies that correlate components of a data storage system to particular power zones. Additionally, the zone policies of the policy module 134 include the definitions of the multiple types of power operating modes that may be employed. The components may be grouped into power zones and the power operating modes assigned to the different power zones. A zone policy also includes implementation points for the various power zones. The implementation points indicate where in a data storage topology that a particular zone policy will be applied.

A manager or an administrator of the data storage system may input zone policy and power zone information into policy module 134. The manager may enter the information via a computer of the data storage system. For example, a client computer of a SAN may be employed to enter the information. Administrative privileges may govern the entry of the zone policy and power zone information. The PZA device 100 may receive the zone policy and power zone information from the upstream or downstream interface 110, 120.

The power operating modes may be defined based on accessibility and/or reliability requirements for data disk drives. In one embodiment, the power operating modes may be defined as a Hot Power Zone, a Warm Power Zone and a Cold Power Zone. A Hot Power Zone may be defined to contain SAN blocks which require “24×7” availability and have all hard disk drives (HDDs) in “Active” power mode as defined per an industry standard, e.g., the SAS-2 specification. An example of a Hot Power Zone includes mission critical SAN deployments. A Warm Power Zone may be defined to contain SAN blocks which do not require “24×7” availability and have all HDDs in “Standby” power mode as defined per an industry standard. A Cold Power Zone may be defined to contain SAN blocks which can be complete powered down at times and be brought back online on-demand. The power up time should not impact end use functionality. This Cold Power Zone would have all HDDs in “Stopped” power mode as defined per an industry standard.

In one embodiment, the policy module 134 may store zone policies in a table format. The table format for the policy data relates to protocols dealing with binary data packets but can be easily extended to be used with any text based protocols. Accordingly, zone policies may also be stored in another format instead of tables. In another embodiment, the policy data could be defined using a CSV (Comma Separated Values) format with a definition for the fields or any other delimited text list format.

As an example of employing tables, the following

TABLE 1
Power Zones defined

| | | | | SAN Block |
|---|---|---|---|---|
| No. | Power Zone | SAN Block | SAN Block Switch | Storage Array |
| 1. | A | X | * | * |
| 2. | B | Y | S12, S15 | * |
| 3. | C | Z | S63 | SA1, SA6 |

tables represent the development and storage of zone policies for a particular data storage system having a SAN topology. The SAN components can be addressed by TCP/IP addresses and/or Serial Attached SCSI addresses. A value of “*” in any field of the Tables 1-3 indicates all the subsystems below or downstream of the component in the previous column. In Table 1, power zones are defined and components are assigned to the various zones.

In the tables, the components may be identified using a human friendly name. For example, SAN block X is placed in Power Zone A and SAN block switches S12 and S15 from SAN block Y are placed in Power Zone B.

In Table 2, the various power zones are assigned a particular kind of power management. Accordingly, an additional column is added to Table 1 and power zones are assigned a power operating mode. As illustrated in Table 2, Hot Power Zone (HPZ) is assigned to Power Zone A, Cold Power Zone (CPZ) is assigned to Power Zone B and Warm Power Zone (WPZ) is assigned to Power Zone C.

TABLE 2
Power Operating Modes applied to the Power Zones

| | | | | SAN | | |
|---|---|---|---|---|---|---|
| | | | SAN | Block | Power | |
| | Power | SAN | Block | Storage | Oper. | |
| No. | Zone | Block | Switch | Array | Mode | PZIP |
| 1. | A | X | * | * | HPZ | PZIP SANBLK |
| 2. | B | Y | S12, S15 | * | CPZ | PZIP SWITCH |
| 3. | C | Z | S63 | SA1, SA6 | WPZ | PZIP |
| | | | | | | STORARRY |

Table 2 to form Table 3. As illustrated, in Table 3, zone policy 1 is implemented at SAN block (i.e., SAN block X). Zone policy 2 is implemented at switches S12 and S15. Zone policy 3 is implemented at storage arrays SA1 and SA6.

TABLE 3
Identify implementation points

| | | SAN | SAN Block | SAN Block | Power |
|---|---|---|---|---|---|
| No. | Power Zone | Block | Switch | Storage Array | Oper. Mode |
| 1. | A | X | * | * | HPZ |
| 2. | B | Y | S12, S15 | * | CPZ |
| 3. | C | Z | S63 | SA1, SA6 | WPZ |

As illustrated in the Tables 1-3, the zone policies allow grouping of storage devices or associated storage devices of a data storage system in defined power zones and defining power operating modes to particular power zones. Various devices of a data storage system can be assigned individually or even hierarchically to power zones. Additionally, points of the data storage system can then be identified to implement the particular power zones.

The zone policies also include multiple features that are used for employing the various power zones that are assigned. Some of the features are based on the order of implementation such as, initial, transition and final power policies. Examples of these features include:

1. Initial Power Policy Type. e.g., HPZ.

2. Initial Power Policy Expiry Time in HH:MM relative to start of activation. e.g., 08:00 means 8 HOURS.

3. Transition Power Policy. e.g., WPZ.

4. Transition Power Policy Expiry Time in HH:MM relative to start of transition. e.g., 02:00 means 2 HOURS.

5. Final Power Policy. e.g., CPZ.

6. Final Power Policy Expiry Time in HH:MM relative to start of transition. e.g., 14:00 means 14 HOURS.

7. Policy Cycle Flag. e.g., SET(1).

The above features may be employed by the management module 138 to direct the operation of an implementation point and those devices below the implementation point. For example, based on the above features 1-7, the management module 138 may direct an implementation point to be in Active state for 8 HRS, then transition to Standby state for 2 HRS and then transition to a Stopped state for 14 HRS. If Policy Cycle is SET to 1, then transition to Active state after 14 HRS.

The policy module 134 may employ a power zone administration table (PZAT) to determine the power zone participants and implement the power zone policies. In one embodiment, the power zone administration table may be a configuration data structure as represented in FIG. 1B. Power zone aware devices will understand the format of the power zone administration table and be able to take actions based on the information contained therein. As illustrated in the embodiment of FIG. 1B, the power zone administration table can be divided into two regions, a Header and a Data region. The power zone administration table of FIG. 1B may be configured to include information in the Header that is used to indicate if a power zone administration table is intended for a switch or an expander. The data structure layout for an embodiment of a power zone administration table is illustrated in FIG. 1B.

The Header is the first row and includes a LENGTH, RESERVED AND TYPE fields. The data portion depends on the TYPE field. LENGTH field can specify the length of the total power zone administration table in DWORDs. A DWORD is a Double Word having a sequence of four data characters or eight-bit each. DATA region of the power zone administration table contains the power zone policy information. The power zone administration table may be communicated to various power zone aware devices of a data storage system via power zone management messages. In one embodiment, the power zone management messages may be Serial Management Protocol (SMP) compliant messages.

In addition to being configured to allow creating the zone policies, the policy module 134 may also be configured to allow an administrator to have privileges that allow activation, modification, deactivation and deletion. Accordingly, the policy module 134 can be configured to create a power zone administration table and then activate the policies by dispatching the power zone administration table to the power zone aware devices and invoke the management module 138 to implement the power zone policies as defined in the power zone administration table. The policy module 134 may also be configured to modify the power zone administration table and reactivate the new power zone administration table. Deactivation may be performed by invoking the management module 138 to rollback a power zone policy. Deletion involves deactivation of the power zone policy and deleting power zone aware devices from the power zone administration tables. An administrator may enter instructions to enter and manipulate the policy module data.

The management module 138 is configured to direct the operation of data disk drives coupled to the power manager 130 according to the power zone policies. The management module 138 is configured to control data disk drives, such as hard disk drives, associated with the PZA device 100 according to the zone policies of the policy module 134. A data disk drive is a data storage device wherein reading and writing information includes moving a storage medium by a read/write head. A hard disk drive is an example of a data disk drive and will be used hereafter in the following embodiments. As such, the management module 138 is configured to spin down idle hard disk drives according to the power zone policies and thereby effectively reduce heat dissipation from spinning hard drives. Accordingly, the management module 138 is configured to receive and interpret power zone management messages and decode the power zone administration table contained therein. The power zone management messages may be SMP compliant, vendor specific or implementation specific messages. Other conventional communication protocols, such as TCP/IP, iSCSI, and FC, may also be employed with modifications. The generic protocol packets may be modified to allow the Power Zone Management/Power Zone Policy information to piggy back on them (existing protocol packets), with the goal of transmission from one end point (management end point) to another end point (managed target/PZA device end point).

In some embodiments, the power zone management messages may have a proprietary protocol employed by the data storage system in which the PZA device 100 is included. The management module 138 is further configured to act on the power zone administration table and implement the power zone policies on that particular node. If required, the management module 138 propagates the power zone management message further downstream of the topology to other devices.

The management module 138 is also configured to provide a configuration option to allow the administrator to choose if a power zone feature should be coupled to SAS-2 zoning feature on a storage switch device, a storage expander device or another device of the network. The management module 138 may provide configuration options via a client computer of a SAN.

FIG. 2 illustrates a block diagram of one embodiment of a data storage system 200 constructed according to the principles of the disclosure. The data storage system 200 has a storage topology of a SAN and represents a single SAN block. In some embodiments, multiple SAN blocks may be coupled together via a network backbone and network links. Client computers may be coupled to a cloud of SAN blocks via a local area network (LAN). The data storage system 200 includes a network 210, a switch 220, a first expander device 230, a second expander device 240, a first storage array 250 and a second storage array 260.

The network 210 provides the interface between application servers and the data storage disks, i.e., the HDDs, of the data storage system 200. Since the data storage system 200 has a SAN topology, the network 210 may be a SAN cloud. In FIG. 2, two application servers 201, 202, are illustrated and coupled to the network 210 of the data storage system 200. The application servers 201, 202, may employ a dual storage controller Host Bus Adapter (HBA) configuration for a multi-path and failover configuration. The network 210 provides multiple paths between the application servers 201, 202, to the first and second storage arrays 250, 260. The storage arrays 250, 260, may include conventional hard disk drives.

The switch 220 is configured to connect the network 210 to the expander devices 230 and 240. The expander device 230 includes an expander 232 and an expander 236. The expander device 240 includes an expander 242 and an expander 244. The expander devices 230, 240, provide connections to the first and second storage arrays 250, 260, via each of the expanders, 234, 238, 244, 248. The expanders 234, 238, 244, 248, may be expander ICs from LSI Corporation.

In addition to being configured to perform switching and connecting functions as in conventional network storage switches and expanders, the switch 220 and the expanding devices 230, 240, may be designated as power zone aware (PZA) devices. As such, implementation points may be used to define the various power zones of the data storage system 200 and the equipment, such as data disk drives, that is included therein.

As mentioned above with respect to FIG. 1, implementation points are locations which can act as the starting boundary points for a particular power zone. With reference to FIG. 2, below are points which can be implementation points. The link 212 between the network 210 and the switch 220 is a first example of an implementation point. For example, if a SAN block is defined in a particular power zone, then all the sub systems below that implementation point may be contained in the same power zone. The links 222, 224, between the switch 220 and the expanding devices 230, 240, are additional examples of implementation points. If a switch is defined in a particular power zone, such as the switch 220, then all the sub systems below that implementation point may be contained in the same power zone. In different embodiments, there may be multiple switch definitions within a single SAN block belonging to different power zones.

A third example of implementation points with respect to FIG. 2 are the links 236, 238, 246 or 248. If a storage array, such as the storage array 250 or 260, is defined in a particular power zone, then all of the sub system (i.e., all hard disk drives) below that implementation point would be contained in the same power zone. In some embodiments, there can be multiple switch definitions and storage array definitions within a SAN block belonging to different power zones.

FIG. 3 illustrates a flow diagram of one embodiment of a method of controlling the spinning of data disk drives of a data storage system carried out according to the principles of the disclosure. A power zone aware device, such as a switch or an expander, may be configured to perform the method 300 as disclosed herein. To perform the described functions, the power zone aware device may include a series of operating instruction stored on a non-transitory computer-readable medium that directs the operation of a processor when initiated thereby. Accordingly, the power zone aware device may include a processor and an associated memory. In one embodiment, the power zone aware device may be a dedicated computing device including the necessary circuitry (including a processor and memory) or software to perform the described functions. The method 300 begins in a step 305.

In a step 310, logical power zones within the data storage system are defined. The data storage system may be a large data center. In one embodiment, the data storage system may have a SAN topology. A SAN cloud having multiple SAN blocks may be included in the data storage system.

In a step 320, power zone policies are defined for each of the logical power zones. Defining the power zone policies may include identifying power operating modes, determining an implementation schedule for the power operating modes and identifying implementation points of the data storage system for applying the power zone policies. Instructions may be received by a policy module to define the power zone policies.

A power zone policy is assigned to each of the logical power zones in a step 330. The power zone policies may be assigned by via the policy module of a power zone aware device.

In a step 340, spinning of data disk drives within each of the logical power zones are controlled based on the power zone policy assigned to each of the logical power zones. The spinning may be controlled by implementing a power zone administration table that relates each one of the logical power zones to each power zone policy assigned thereto. The power zone administration table may be generated by the policy module before being used for the controlling. In one embodiment, the controlling includes communicating the power zone administration table to the data disk drives. A switch or an expander of the data storage system may be configured to perform the controlling. In a step 350, the method 300 ends.

The above-described apparatuses and methods may be embodied in or performed by various digital data processors or computers, wherein the computers are programmed or store executable programs of sequences of software instructions to perform one or more of the steps of the methods e.g., steps of the methods or processes of FIG. 3. The software instructions of such programs may represent algorithms and be encoded in machine-executable form on conventional digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods. Accordingly, computer storage products with a computer-readable medium, such as a non-transitory computer-readable medium, that have program code thereon for performing various computer-implemented operations that embody the tools or carry out the steps of the methods set forth herein may be employed. A non-transitory media includes all computer-readable media except for a transitory, propagating signal. The media and program code may be specially designed and constructed for the purposes of the disclosure, or they may be of the kind well known and available to those having skill in the computer software arts. An apparatus, such as a switch or an expander, may be designed to include the necessary circuitry or series of operating instructions to perform each step of the disclosed methods. In one embodiment, the particular functions described herein may be integrated with a processor or a controller of the switch, expander or other storage system device.

Those skilled in the art to which this application relates will appreciate that other and further additions, deletions, substitutions and modifications may be made to the described embodiments.

What is claimed is:

1. A power zone aware device of a data storage system, comprising:
a policy module configured to define at least one power zone in said data storage system and assign a power zone policy thereto; and
a management module coupled configured to direct operation of data disk drives in said power zone based on said power zone policy.

2. The power zone aware device as recited in claim 1 wherein said power zone policy includes at least one power operating mode for said data disk drives.

3. The power zone aware device as recited in claim 2 wherein said power zone policy includes an implementation schedule for said at least one power operating mode.

4. The power zone aware device as recited in claim 1 wherein said power zone policy includes an implementation point in said data storage system.

5. The power zone aware device as recited in claim 1 wherein said power zone policy includes multiple power operating modes for said data disk drives and an implementation schedule for applying said multiple power operating modes to said data disk drives.

6. The power zone aware device as recited in claim 1 wherein said data disk drives are sub-components of said power zone aware device in said data storage system.

7. The power zone aware device as recited in claim 1 wherein said power zone aware device is a switch or an expander of said data storage system.

8. A method of controlling spinning of data disk drives in a data storage system, comprising:
defining logical power zones within said data storage system;
assigning a power zone policy to each of said logical power zones; and
controlling spinning of data disk drives within each of said logical power zones based on said power zone policy assigned to said each of said logical power zones.

9. The method as recited in claim 8 further comprising defining each said power zone policy, including identifying at least one power operating mode therefor.

10. The method as recited in claim 9 wherein said defining each said power zone policy includes identifying multiple power operating modes therefor and determining an implementation schedule for said multiple power operating modes.

11. The method as recited in claim 9 wherein said defining said power zone policy includes identifying an implementation point in said data storage system for each of said logical power zones.

12. The method as recited in claim 8 wherein said controlling includes implementing a power zone administration table that relates each one of said logical power zones to each said power zone policy assigned thereto.

13. The method as recited in claim 8 wherein said controlling includes communicating said power zone administration table to said data disk drives.

14. The method as recited in claim 1 wherein said controlling is performed by a switch or an expander of said data storage system.

15. A data storage system, comprising:
multiple data disk drives; and
a power zone aware device coupled to said multiple data disk drives, said power zone aware device including:
a policy module configured to define at least one power zone for said multiple data disk drives and assign a power zone policy thereto; and
a management module configured to direct operation of said multiple data disk drives in said power zone based on said power zone policy.

16. The data storage system as recited in claim 15 wherein said power zone policy includes at least one power operating mode for said multiple data disk drives in said power zone.

17. The data storage system as recited in claim 16 wherein said power zone policy includes an implementation schedule for said at least one power operating mode.

18. The data storage system as recited in claim 15 wherein said power zone policy includes an implementation point in said data storage system.

19. The data storage system as recited in claim 15 wherein said power zone policy includes multiple power operating modes for said multiple data disk drives and an implementation schedule for applying said multiple power operating modes to said multiple data disk drives.

20. The data storage system as recited in claim 15 wherein said power zone aware device is a switch of said data storage system.

21. The data storage system as recited in claim 15 wherein said power zone aware device is an expander of said data storage system.
